(19) United States
(12) Patent Application Publication
(10) Pub. No.: US 2023/0263351 A1
(43) Pub. Date: Aug. 24, 2023

(54) Filter device and method for dedusting same

(71) Applicant: Hilti Aktiengesellschaft, Schaan (LI)

(72) Inventor: Oliver OHLENDORF, Landsberg (DE)

(21) Appl. No.: 18/024,372

(22) PCT Filed: Sep. 10, 2021
(86) PCT No.: PCT/EP2021/074947

§ 371 Date: Mar. 2, 2023

(30) Foreign Application Priority Data
Sep. 23, 2020 (EP) 20197753.5

(51) Int. Cl. A47L 9/20; A47L 9/12; A47L 9/14; A47L 5/36; B01D 46/10; B01D 46/00; B01D 46/42; B01D 46/71; B01D 46/74; B01D 46/58; F16K 15/14

(52) U.S. Cl. CPC A47L 9/20; A47L 9/122; A47L 9/1409; A47L 5/365; B01D 46/10; B01D 46/0043; B01D 46/4272; B01D 46/71; B01D 46/74; B01D 46/58; F16K 15/147; B01D 2273/30; B01D 2279/55

(57) ABSTRACT

A filter device for a vacuum cleaner having a turbine device and a motor. The vacuum cleaner includes two chambers and filter elements of the filter device are dedusted by an abrupt change in position of a dividing element in the chambers. Since, when one of the two chambers is being dedusted, the suction operation of the vacuum cleaner can be maintained through the other chamber, the filter dedusting can advantageously take place during continued suction operation of the vacuum cleaner. A method for dedusting a filter device in a vacuum cleaner, wherein, as a result of a valve being actuated, an air volume is driven out of one of the two chambers so that a dividing element is advantageously made to change position, and this can result in a backflushing pulse and mechanical shaking of the filter element, and dedusting of the filter device.

The invention relates to a filter device for a vacuum cleaner having a turbine device and a motor for generating a first and/or a second main air stream through a collecting tank of the vacuum cleaner.

### BACKGROUND

On construction sites, use is often made of vacuum cleaners in order to suck up or suck in dirt particles in the form of dust, drilling dust or the like. In order to collect the dirt, a negative pressure is generated inside the vacuum cleaner by means of a turbine. Via a hose, which is connected to the vacuum cleaner, the negative pressure is used in order to suck up the dirt particles and transport them into a collecting tank of the vacuum cleaner. Commercially available vacuum cleaners are usually built such that the turbine, a filter, the collecting tank and the inlet opening for the sucked-in dirt particles are located one after another, or on a flow path. Usually, the filter is positioned between the collecting tank, or the inlet opening for the sucked-in dirt particles, and the turbine that generates a negative pressure. Since the sucked-in air containing dirt particles would flow through the turbine and consequently soil or damage the turbine, the filter serves to clean the sucked-in air and thus in particular to protect the turbine.

### SUMMARY OF THE INVENTION

However, a problem can arise when the filter can no longer provide a sufficient filtering function and sucked-in dirt particles can no longer be filtered out of the air flowing through the filter. This is the case in particular when, on account of the vacuum cleaner being used for a relatively long time, the filter is increasingly dirty, i.e. filled with dirt particles. In order to keep the filter functional, it has to be intermittently cleaned and freed of the dirt particles it has taken up. However, to clean the filter in commercially available vacuum cleaners, said vacuum cleaners have to be switched off, or the operation thereof interrupted, so that the cleaner can be opened and the filter taken out in order to remove the dirt particles it has taken up. Such activities interrupt the vacuuming process, however, and are very time-consuming.

According to the prior art, there already also exist vacuum cleaners that have an apparatus for dedusting the filter without the vacuum cleaner having to be switched off, opened and the filter taken out in order to remove the dirt particles it has taken up. A drawback of such apparatuses, however, is that, even in these vacuum cleaners, suction operation of the vacuum cleaner has to be interrupted while the filter is being dedusted. Alternatively, the suction operation can be continued with reduced power. In most cases, as a result of the suction being interrupted, the extraction performance of the vacuum cleaner drops and dust particles undesirably escape into the atmosphere, where they increase the dust concentration. Frequently, known filter dedusting apparatuses have a complex structure and are assembled from a large number of components. As a result, conventional filter dedusting apparatuses, as are known from the prior art, are frequently susceptible to faults or wear or in need of servicing.

It is an object of the present invention to overcome the above-described deficiencies and drawbacks of the prior art and to provide an improved filter device for a vacuum cleaner, with which suction operation of the vacuum cleaner does not have to be interrupted while the filter is being dedusted.

The present invention provides a filter device for a vacuum cleaner, wherein the vacuum cleaner comprises a turbine device and a motor for generating a first and/or a second main air stream through a collecting tank of the vacuum cleaner. The filter device is characterized by the following features and components:
a first chamber and a second chamber, each with a filter element, an inflow opening and a turbine opening, wherein a valve is designed to close either the inflow opening or the turbine opening, wherein a negative pressure prevails in the chamber when the inflow opening is closed and wherein atmospheric pressure prevails in the chamber when the inflow opening is open,
wherein the chambers also each comprise a dividing element,
wherein the dividing elements can be in a parked position and in a dedusting position,
wherein a switchover between the parked position and the dedusting position takes place by letting in the atmospheric pressure, this being effected by actuating the valve,
wherein the dividing elements are designed to apply a pulse to the respective filter element when the dedusting position is taken up, such that the filter element is dedusted.

Tests have shown that the filter device ensures a good and interruption-free extraction performance. As a result of the advantageous cooperation and the specific design of the valves and the dividing elements, and the pressure distribution, controlled thereby, in the different regions of the vacuum cleaner, alternate dedusting of the two chambers with, at the same time, ongoing suction operation of the other chamber in each case can be allowed. As a result, a highly efficient possibility, optimized in terms of installation space, for filter dedusting is advantageously provided in a vacuum cleaner. The filter device in particular has a relatively simple structure. Use tests have shown that the filter device is particularly robust and not very susceptible to repairs and wear. In particular the dividing elements provided in the chambers contribute to these advantages of the invention, said dividing elements, according to a preferred configuration of the invention, comprising a membrane plate and an integrated elastomer valve. In this configuration of the invention, it is preferred that the membrane plate is designed to apply a dedusting pulse to the respective filter element when the dedusting position is taken up. According to the invention, this dedusting pulse can also be referred to as backflushing pulse. In addition to the backflushing pulse, the filter element is mechanically shaken by the opening of the valve. As a result of the shaking, dust particles and filter cakes are detached from the filter element and can drop into the collecting tank of the vacuum cleaner. The shaking of the filter element preferably represents backflushing of the filter device, this being used in the context of the present invention in order to dedust the filter of the vacuum cleaner.

According to the invention, it is preferred that the dividing elements are designed to be movable within the chambers. The provision of a first and a second chamber in the context of the filter device should be understood as meaning that the filter device preferably has at least two chambers. According to the invention, it may also be preferred that the filter device has more than two chambers, for example three or four chambers.

According to the invention, the movability of the dividing elements preferably means that the dividing elements can be arranged in two different positions within the respective chamber, specifically in a parked position or in a dedusting position. A dividing element preferably comprises a membrane plate, an elastomer valve and two pleats, which are preferably in the form of elastomer pleats. These pleats are preferably designed to be in two states, wherein a first state of the pleats corresponds to the parked position of the dividing element or of the membrane plate, while a second state of the pleats corresponds to the dedusting position of the dividing element or of the membrane plate. The two different states in which the pleats of the dividing elements can be arranged are indicated for example in FIG. 4, in which the pleats of the chambers are arranged in different states. In the first chamber of the vacuum cleaner, which is illustrated in the left-hand half of the figure, the dividing element, and thus the membrane plate and the pleat, is in the suction operation position, which is also referred to as the parked position according to the invention. In the second chamber of the vacuum cleaner, which is illustrated in the right-hand half of FIG. 4, the dividing element, and thus the membrane plate and the pleat, is in the dedusting position.

The membrane plates of the dividing elements can preferably be fastened to the inner walls of the chambers using the pleats. According to a preferred configuration of the invention, the membrane plates can be oriented substantially vertically within the chambers, such that they are oriented substantially parallel to the filter elements and a partition wall between the chambers. In this configuration of the invention, it is preferred that the membrane plates with the pleats are fastened to the inner top side and to the inner underside of the first or of the second chamber.

In the parked position, the dividing elements are designed to split the chambers of the vacuum cleaner into a front space and a rear space. The front chamber is preferably arranged in the vicinity of the filter element of the respective chamber, while the rear space of the chamber is preferably bounded by a partition wall between the first and the second chamber, and by a further side wall, which has an inflow opening and a turbine opening. According to the invention, it is preferred that the further side wall delimits the chamber, or its rear space, from a ventilation channel. According to the invention, it is preferred that the front space of a chamber is formed between the filter element and the dividing element and the rear space comprises the outflow opening and a turbine opening. The inflow opening and the turbine opening of the rear space of the first or of the second chamber can be closed or opened up by a valve, wherein in each case one of the two openings is closed while the other opening is open. In other words, according to the invention, it is preferred that each of the two chambers comprises a valve, wherein the valves are designed to close either the inflow opening or the turbine opening of a chamber and to allow a flow through the other opening in each case. Preferably, the opening of the inflow opening results in the turbine opening being closed, and vice versa.

According to the invention, it is preferred that the two chambers of the vacuum cleaner each have a valve. Preferably, there can be a connection between the valves of the individual chambers in order that actuation of the one valve causes the other valve to be actuated. However, it may also be preferred for the valves to be embodied as one component. According to the invention, it is preferred that the valves are designed to close or open up openings to the atmospheric air side or to the environment of the vacuum cleaner. The valves can be configured for example as slide valves which can be moved or slid back and forth between an open position and a closed position. The valves represent in particular controllable openings, i.e. openings which can preferably be opened or closed automatically. According to the invention, it is particularly preferred that the opening and closing of the valves can be controlled. The valves represent in particular regulating elements with which the pressure or the pressure conditions in the vacuum cleaner can be regulated. In particular, an opening cross section of the turbine opening or inflow opening can be set with the valves.

According to the invention, it is preferred that the turbine opening is designed to allow a flow connection between one of the chambers and the turbine, wherein this flow connection exists between the chambers and the turbine device in particular during operation of the vacuum cleaner. Preferably, the flow connection is formed by a flow channel portion that is formed between the turbine opening of one of the chambers and the turbine. This flow channel portion is open in particular during operation of the vacuum cleaner in order that the negative pressure generated by the turbine can be used to suck in or up dust. According to the invention, the position of the valve in which suction operation is allowed through the respective chamber is preferably referred to as the “first position” or “suction operation position” of the valve. In this first position of the valve, the turbine opening of one chamber is open while the inflow opening to the ventilation channel is closed. In the second position of the valve, which is also referred to as the dedusting position according to the invention, the turbine opening is closed, while the inflow opening is open.

According to the invention, it is preferred that a negative pressure prevails in the corresponding chamber when the associated inflow opening is closed and the turbine opening is open, i.e. the valve of the corresponding chamber is in the suction operation position. In this case, extraction operation takes place through the corresponding chamber and dust particles can be sucked into the collecting tank by the associated main air stream. According to the invention, it is also preferred that, during suction operation through the one chamber, the filter element in the other chamber can be dedusted. In order to bring about the dedusting of the filter element, the valve of the other chamber can be actuated such that an inflow opening is opened and the turbine opening is closed. As a result, atmospheric pressure enters this chamber to be dedusted.

According to the invention, it is provided that each chamber comprises a dividing element which can be in a parked position and in a dedusting position. A switchover between the parked position and the dedusting position can advantageously take place by letting in the atmospheric pressure, wherein the letting in is effected by actuating the valve. According to the invention, the actuation of the valve means preferably that the valve is shifted from the first position into the second, or vice versa. In other words, upon actuation of the valve, the valve is moved from the suction operation position into the filter dedusting position, or vice versa. The dividing elements are designed to apply a pulse to the respective filter element when the dedusting position is taken up, such that the filter element is dedusted. In particular, a dedusting shock or a dedusting pulse is applied to the filter element by the dividing element. The dividing elements can have membrane plates and elastomer valves, wherein the elastomer valves are in an open position during suction operation (inflow opening closed, turbine opening open). In other words, the dividing elements, in addition to the membrane plates, can have elastomer valves, wherein the elastomer valves can bear against the membrane plates and prevent an air flow through the membrane plate by bearing against it (“closed state”) or wherein the elastomer valves can form, between the elastomer valve and membrane plate, a gap through which an air flow can flow (“open state”). Preferably, a gap between the elastomer valve and membrane plate is preferably formed in that the elastomer valve is fastened to the membrane plate on one side and can be present at a spacing from the membrane plate on the other side of the membrane plate. According to the invention, it is preferred that the elastomer valve is fastened to the membrane plane on at least one side. In other words, the elastomer valve can be fastened to the membrane plate on more than one side. In the open position, the elastomer valves allow the main air streams, which form between the dust collecting tank and turbine during suction operation, through an opening between the elastomer valve and membrane plate of the dividing element. If the valve is now moved from the suction operation position into the filter dedusting position, the negative pressure in the chamber to be dedusted is weakened, wherein the suction operation of the vacuuming apparatus can advantageously be maintained through the other chamber. According to the invention, the weakening of the negative pressure can be brought about in that a pressure equalizing stream is guided into the chamber to be dedusted from the environment of the vacuum cleaner. This preferably takes place through the ventilation channel and the inflow opening of the corresponding chambers. The letting in of the pressure equalizing stream may also have the result that a negative pressure no longer prevails in the chamber to be dedusted.

According to the invention, it is preferred that, as a result of the valve being actuated, the inflow opening between the chamber and ventilation channel is opened such that, on account of the negative pressure, existing during suction operation, in the chamber, an air stream (“pressure equalizing stream”) into the chamber arises, said air stream pushing the elastomer valve against the membrane plate. As a result, the elastomer valve is closed and the main air stream that forms between the dust collecting tank and turbine during suction operation is no longer allowed through by the elastomer valve. In other words, the dividing element blocks one of the two main air streams in this case of the turbine opening being closed and the inflow opening being open (“filter dedusting position”). As a result of the air blast that penetrates abruptly through the opened inflow opening, not only is the elastomer valve pushed against the membrane plate and as a result closed, but also the dividing element is accelerated with great force or high acceleration in the direction of the filter element of the corresponding chamber. In the context of the present invention, this abrupt movement of the dividing element is referred to as “taking up the dedusting position”, with the result that the dividing element applies a backflushing pulse to the respective filter element. As a result of this pulse, the filter element can preferably additionally be mechanically shaken, such that advantageously the filter element is mechanically dedusted. Preferably, the pulse can be transmitted by contact between the dividing and filter element or contactlessly by compression of the air between the elements.

According to the invention, it is preferred that a mechanical stop is provided between the dividing element and the filter element. This stop can be formed for example as a grating or as a grating element. Preferably, the mechanical stop is designed to transmit a shock pulse or the backflushing pulse to the filter element.

According to the invention, it is preferred that the ventilation channels are arranged between the collecting tank and the suction head. The collecting tank forms the lower region of the vacuum cleaner, in which the dust sucked in by the vacuum cleaner is captured and stored until the vacuum cleaner is emptied. According to the invention, it is preferred that the first and the second chamber are constituents of the collecting tank. In other words, the first chamber and the second chamber are arranged in the collecting tank of the vacuum cleaner. In a preferred configuration of the invention, the chambers have inlet openings which are delimited with respect to the collecting tank by filter elements. Preferably, the filter elements are designed to close off the inlet openings such that dust particles can be filtered out of the main air streams, wherein, during suction operation, the main air streams are formed between the suction hose inlet of the dust collecting tank and the turbine. It is these filter elements between the chambers and the remaining volume of the collecting tank that are intended to be dedusted in the context of the present invention. As a result of the direct and immediate connection between the filter elements and the collecting tank, dust particles and filter cakes that are detached from the filter elements during dedusting can pass directly into the collecting tank and be disposed of the next time the tank is emptied.

The suction head preferably forms the upper region of the vacuum cleaner; it is preferably also referred to as the “vacuum cleaner head”. The suction head preferably comprises the turbine device of the vacuum cleaner, and a motor. According to the invention, it is preferred that the turbine is a constituent of an extraction device within the vacuum cleaner. The motor serves to drive the turbine, or to allow operation of the vacuum cleaner. Arranged between the suction head and the collecting tank are ventilation channels, which can be delimited toward the outside, i.e. with respect to the environment of the vacuum cleaner, by subregions of the cleaner housing. These subregions of the cleaner housing preferably have ventilation openings or ventilation slots, through which air can be sucked into the interior of the vacuum cleaner. According to the invention, it is particularly preferred that the air is sucked into the ventilation channels, wherein the air can pass from there into the chambers of the filter device. The air stream from the ventilation channel into the chamber to be dedusted forms, in a particularly preferred configuration of the invention, a pressure equalizing stream, which can pass through the open valve and through the inflow opening from the ventilation channel into the chamber. In other words, when the first or second valve is opened, a pressure equalizing stream can pass into the first chamber or into the second chamber of the vacuum cleaner. According to the invention, it is preferred that the valves can each be moved, i.e. opened or closed, by a respective adjusting element. The adjusting elements can be present for example in the ventilation channels, preferably in the vicinity of the further side wall, which preferably forms a partition wall between the ventilation channel and the first or the second chamber of the vacuum cleaner.

According to the invention, it is preferred that, during operation of the vacuum cleaner, a negative pressure prevails in the collecting tank and in at least one of the two chambers. Preferably, the negative pressure can be generated by the turbine device in the suction head. By means of the negative pressure, dust particles or drilling dust can be sucked into the interior of the vacuum cleaner. The collecting tank of the vacuum cleaner preferably has a suction hose inlet, through which the dust particles or the drilling dust can be sucked in, in particular when the inlet is connected to a suction hose and the vacuum cleaner is in suction operation. Suction operation is preferably characterized in that the vacuum cleaner generates a negative pressure with its turbine device. The suction operation generates main air streams through the chambers of the vacuum cleaner that participate in suction operation, wherein the main air streams preferably flow from the suction hose inlet to the turbine device. The first main air stream passes through the suction hose inlet into the collecting tank and flows through the first filter element into the front region of the first chamber. Through the membrane plate of the first dividing element, the first main air stream flows into the rear space of the first chamber. When the first chamber participates in the suction operation of the vacuum cleaner, the inflow opening of the first chamber is closed by the valve (suction operation position of the valve). According to the invention, it is preferred that the rear spaces of the chambers are in a flow connection with the turbine device of the vacuum cleaner. To this end, the chambers each comprise a turbine opening, which is formed by an opening which allows a flow connection between the chambers and the turbine device. According to the invention, it is preferred that this turbine opening can be opened or closed by the same valve that opens or closes the inflow opening of the corresponding chamber. According to the invention, it is very particularly preferred that the valve is configured such that it closes either the inflow opening of a chamber or the turbine opening of a chamber. In other words, in each case either the inflow opening or the turbine opening of the rear space of a chamber is closed by the valve, while the respectively other opening is open. According to the invention, it is preferred that the valve comprises an opening which can coincide either with the inflow opening or the turbine opening of a chamber by means of a lateral displacement movement. The respective opening of the chamber which coincides with opening of the valve is then in an open state, wherein the inflow opening leads into the ventilation channel, while the turbine opening leads into a short channel portion in the direction of the turbine device (“flow channel portion”).

According to the invention, it is preferred that the chambers each comprise an inflow opening and a turbine opening, wherein the turbine openings are designed to allow a flow connection between the chambers and the turbine device. In this case, it is preferred that the valves are designed to close either the inflow opening or the turbine opening of a chamber and to allow a flow through the other opening in each case.

In one exemplary embodiment of the invention, it is preferred that, in a vacuuming apparatus,
a first chamber comprises a first filter element and a first inflow opening, wherein the first inflow opening is closable with respect to a first ventilation channel by a first valve, wherein the first chamber also comprises a first dividing element which can have a first membrane plate and a first elastomer valve; and
a second chamber comprises a second filter element and a second inflow opening, wherein the second inflow opening is closable with respect to a second ventilation channel by a second valve, wherein the second chamber also comprises a second dividing element which can have a second membrane plate and a second elastomer valve,
wherein the dividing element or its membrane plate can be in a parked position and in a dedusting position, wherein a switchover between the parked position and the dedusting position takes place by means of atmospheric pressure, which is able to be created in the first chamber or in the second chamber by opening the first valve or the second valve, wherein the membrane plates or the corresponding dividing elements are designed, when the dedusting position is taken up, to apply a backflushing pulse to the respective filter element such that a backflushing air movement and any additional mechanical shaking and, as a result, dedusting of the respective filter element is brought about.

According to the invention, it is preferred that a switchover between the parked position and the dedusting position of the membrane plate or of the dividing element takes place via a pleat. According to the invention, it is preferred that the pleat is a constituent of the dividing element. In particular, the pleat connects the membrane plate of the dividing element to the side walls of the chamber, wherein the dividing element or the membrane plate can be arranged in different positions within the chamber as a result of the different positions that the pleat can take up. When the valve is in the suction operation position, the dividing element or the membrane plate preferably takes up what is known as the parked position, in which the main air stream is allowed through between the dust collecting tank and turbine by the elastomer valve. When the valve is in the dedusting position, the dividing element or the membrane plate preferably takes up the dedusting position, in which the dividing element or the membrane plate or the elastomer valve blocks the main air stream between the dust collecting tank and turbine. The pleat is preferably made from an elastic material that can be subjected to mechanical stress. As a result of the mechanical stress, a snap action effect can occur, which has the result that a sudden switchover between the parked position and the dedusting position of the pleat can occur. In other words, it is preferred according to the invention that the switchover between the parked position and the dedusting position takes place suddenly. As a result, a sudden pulse is transmitted from the dividing element to the filter element, against which the dividing element can butt when it passes from the parked position into the dedusting position. As a result of this sudden pulse transmission from the dividing element to the filter element, the filter element is advantageously cleaned by the displaced air volume in the opposite direction of flow and is furthermore mechanically shaken, such that any adhering filter cake or particles sticking loosely in the filter are shaken off the filter element and drop into the dust collecting tank on account of gravity.

According to the invention, it is preferred that a gap between the elastomer valve and membrane plate is formed in that the elastomer valve is fastened to the membrane plate on one side and can be present at a spacing from the membrane plate on the other side of the membrane plate. The main air stream, which flows between the suction hose inlet and the turbine in suction operation, can be let through this gap or spacing.

In a second aspect, the invention relates to a method for dedusting a filter device in a vacuum cleaner, wherein the method is characterized by the following method steps:
a) providing a filter device in a vacuum cleaner,
b) operating the vacuum cleaner, wherein, during operation of the vacuum cleaner, a negative pressure prevails in a collecting tank of the vacuum cleaner and in at least a first chamber and/or in a second chamber of the vacuum cleaner,
c) generating atmospheric pressure in one of the chambers by actuating a valve, wherein, as a result of the valve being actuated, a turbine opening of the chamber is closed and an inflow opening of the chamber is opened and furthermore a dividing element within the chamber is made to change position from a parked position into a dedusting position,
d) dedusting a filter element by the change in position of the dividing element.

According to the invention, it is preferred that the change in position of the dividing element can preferably also be referred to as a position change or as a switchover from a first position into a second. This change in position takes place preferably suddenly or abruptly, such that the dividing element, or its membrane plate is moved with a large impulse. Preferably, this shock takes place via the switchover of a pleat by which the membrane plate of the dividing element is fastened to the side walls of the chamber. The change in state of the pleat corresponds preferably to an abrupt change in state, as for example in the case of a snap action effect, wherein this abrupt change in state and the striking, advantageously brought about thereby, of the filter element result in mechanical shaking which causes the filter element to be dedusted.

According to the invention, it is preferred that, as a result of the valve being actuated, the air volume is driven out of one of the two chambers by the inflow opening being opened up and the turbine opening being closed. In this case, in particular the flow or opening cross section of the inflow opening is opened up by the valve, which is preferably in the form of a regulating element or slide valve, being shifted from a parked position into a dedusting position. As a result of this change in pressure, the dividing element can advantageously be made to change position, and this, in addition to the backflushing pulse, results in mechanical shaking of the filter element and dedusting of the filter device.

According to the invention, it is preferred that the filter elements of the filter device can be dedusted alternately. The respectively other chamber then ensures the suction operation of the vacuum cleaner. Preferably, the filter dedusting processes can take place substantially seamlessly, i.e. without a break and a time delay. However, according to the invention, it may also be preferred for there to be breaks between the filter dedusting processes of the chambers. In these breaks, it is preferred for both chambers to participate in the suction operation of the vacuum cleaner.

According to the invention, it is preferred that, when the inflow opening is opened, a pressure equalizing stream passes into the first chamber or into the second chamber, with the result that atmospheric pressure is generated in the corresponding chamber. According to the invention, it is furthermore preferred that the pressure equalizing stream is sucked in from a ventilation channel, wherein the ventilation channel can be arranged between the chambers and the suction head.

In an advantageous configuration of the invention, it is preferred that, during operation of the vacuum cleaner, there is a flow connection between the chambers and the turbine device, wherein the flow connection represents a flow channel portion that is formed between a turbine opening of one of the chambers and the turbine device. According to the invention, it is preferred that the first main air stream and/or the second main air stream can flow through this flow connection.

It is an essential advantage of the invention that the dedusting of the filter element of one chamber can take place while suction operation through the other chamber continues.

In particular, the invention also relates to a vacuum cleaner having a filter device according to the invention. The definitions, technical effects and advantages that have been described for the filter device apply analogously to the filter dedusting method and the vacuum cleaner, which has the present filter device.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to produce useful further combinations.

In the figures, identical and similar components are denoted by the same reference signs.

In the figures:

FIG. 1 shows a schematic side view of a vacuum cleaner having a preferred embodiment of the filter device in a vertical arrangement

FIG. 2 shows a schematic illustration of the vacuum cleaner while both chambers are participating in suction operation

FIG. 3 shows a schematic illustration of the vacuum cleaner while the filter element of the second chamber is being dedusted

FIG. 4 shows a schematic illustration of the vacuum cleaner while the filter element of the second chamber is being dedusted

FIG. 5 shows a schematic illustration of the vacuum cleaner at the end of the dedusting process of the second chamber

FIG. 6 shows a schematic illustration of the vacuum cleaner while the filter element of the first chamber is being dedusted

FIG. 7 shows a schematic illustration of the vacuum cleaner while the filter element of the first chamber is being dedusted

FIG. 8 shows a schematic illustration of the vacuum cleaner at the end of the dedusting process of the first chamber

FIG. 9 shows possible configurations of the pleat

FIG. 10 shows a schematic side view of a vacuum cleaner having a preferred embodiment of the filter device in a horizontal arrangement

### DETAILED DESCRIPTION

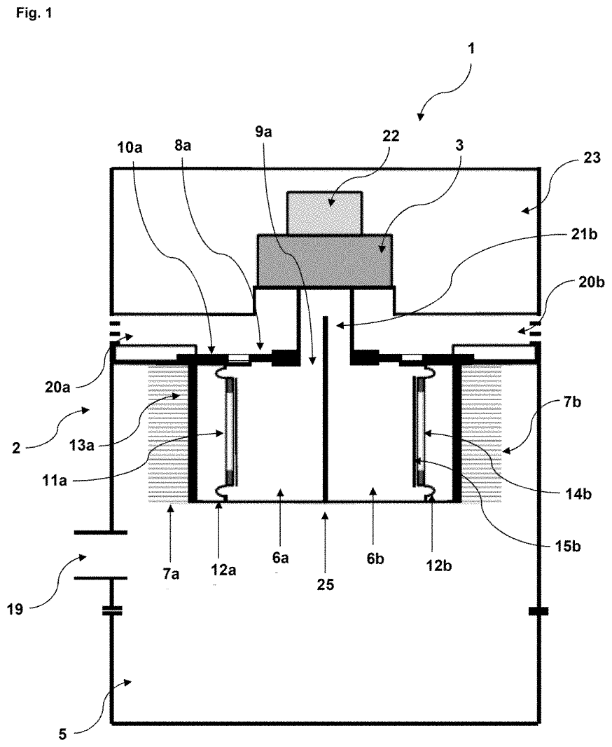

FIG. 1 shows a side view of a vacuum cleaner 1 having a preferred embodiment of the filter device 2 in a vertical arrangement. Illustrated in a lower region of the vacuum cleaner 1 is the dust collecting tank 5, which has a suction hose inlet 19. A suction hose, which can be connected for example to a floor nozzle, can be attached to this suction hose inlet 19. Through the suction hose, dust particles or drilling dust can be sucked in. The sucked-in dust then passes through the suction hose inlet 19 into the dust collecting tank 5 of the vacuum cleaner 1.

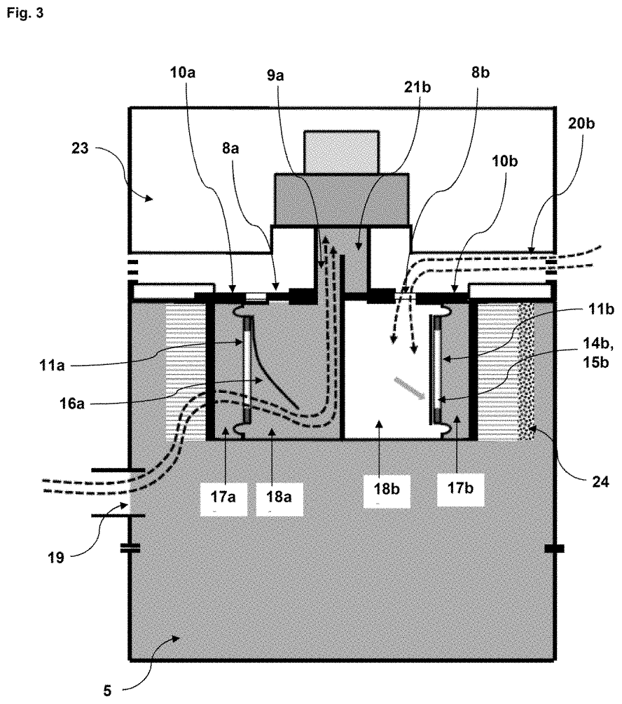

The upper region of the vacuum cleaner 1 is formed by a vacuum cleaner head 23. Located in the vacuum cleaner head are, for example, the turbine 3 and the motor 22, with which the negative pressure for sucking in the dust particles and drilling dust is generated. Provided between the vacuum cleaner head 23 and the dust collecting tank 5 are ventilation channels 20a and 20b with which air can be sucked in from the environment of the vacuum cleaner 1 through openings in the housing. This air sucked in through the ventilation channels 20, 20b can form for example a pressure equalizing stream when pressure equalization is intended to take place in the vacuum cleaner 1. This can be the case for example when the negative pressure within the vacuum cleaner 1 is intended to be interrupted in order to carry out filter dedusting. It is necessary to dedust the filter elements 7a, 7b for example when the filter elements 7a, 7b of the filter device 2 are clogged with dust. The initially loose dust can solidify to form a filter cake 24 (see, e.g., FIG. 3), which can be detached from the filter elements 7a, 7b only with difficulty. In order to provide effective filter dedusting in which in particular the suction operation of the vacuum cleaner 1 does not need to be interrupted, the invention is presented in the following text:

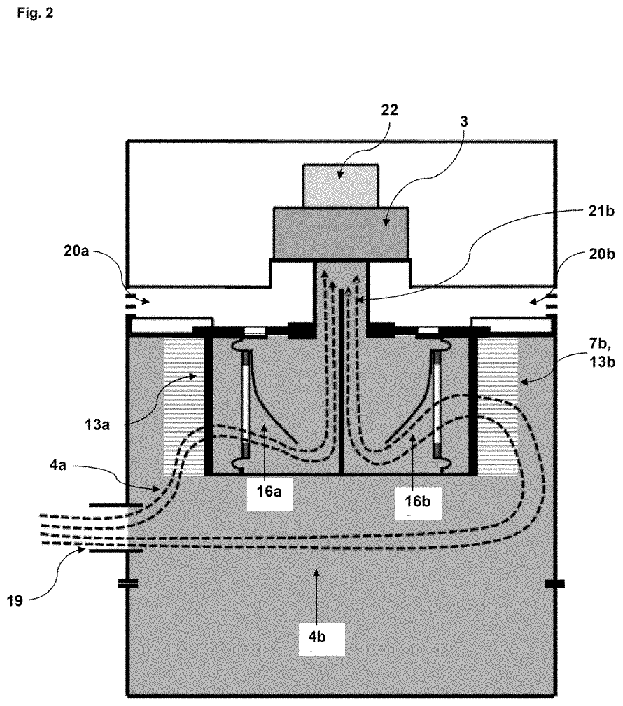

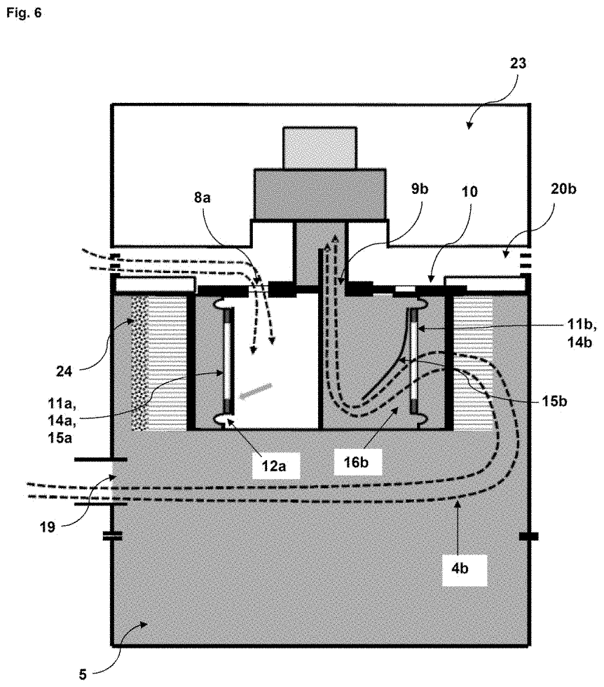

Provided between the dust collecting tank 5 and the vacuum cleaner head 23 are two chambers 6a, 6b, the filters 7a, 7b of which can be dedusted alternately according to the invention, while the suction operation of the vacuum cleaner 1 can be continued in the respectively other chamber 6a, 6b. The chambers 6a, 6b are formed in a substantially identical manner, but axisymmetrically to a partition wall 25 separating the two chambers, and so in particular the first chamber 6a is described in the following text. This is the left-hand chamber in FIG. 1. Located in terms of flow in a front region of the chamber 6a is an inlet opening 13a, through which the dust-laden air stream 4a (see, e.g., FIG. 2) is sucked from the dust collecting tank 5 in the direction of the turbine 3. In order to protect the turbine 3 from the dust, a filter element 7a is provided upstream of the inflow opening 13a, said filter element 7a being designed to filter a substantial proportion of the dust out of the air stream 4a. Once the air stream 4a has passed through the inlet opening 13a and the filter element 7a, the air stream 4a passes into a front space 17a (see, e.g., FIG. 3) of the first chamber 6a. The first chamber 6a is divided by a dividing element 11a into the front region 17a and a rear region 18a. The dividing element 11a is configured such that the air stream 4a can flow through the dividing element 11a such that it passes into the rear region 18a of the first chamber 6a. In particular, the dividing element 11a comprises an air- and dust-permeable membrane plate 14a (see, e.g., FIG. 6), which is fastened to the side walls of the first chamber 6a by a respective pleat 12a. The pleats 12a can be present in two states, wherein the pleats 12a are preferably in a parked position during suction operation of the first chamber 6a. The parked position of the pleats 12a or of the membrane plate 14a is in particular characterized in that the membrane plate 14a and the filter element 7a of the first chamber 6a are spaced apart from one another, i.e. that a space is formed between the membrane plate 14a and the filter element 7a, said space being referred to, according to the invention, as the front region 17a of the first chamber 6a.

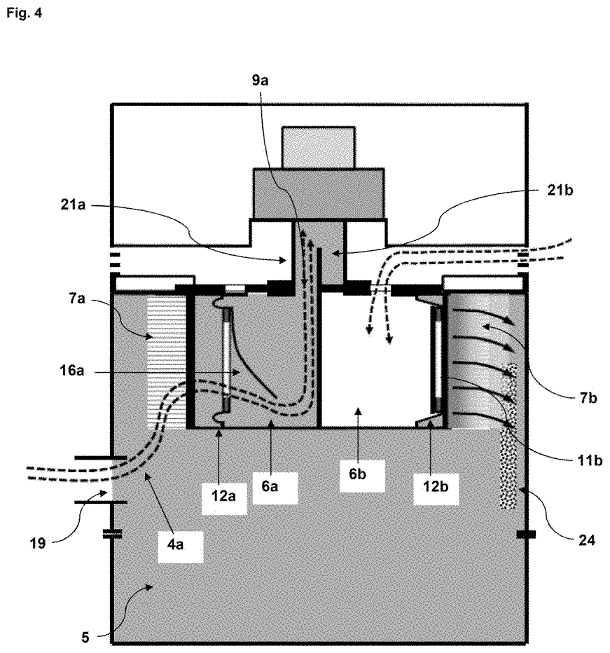

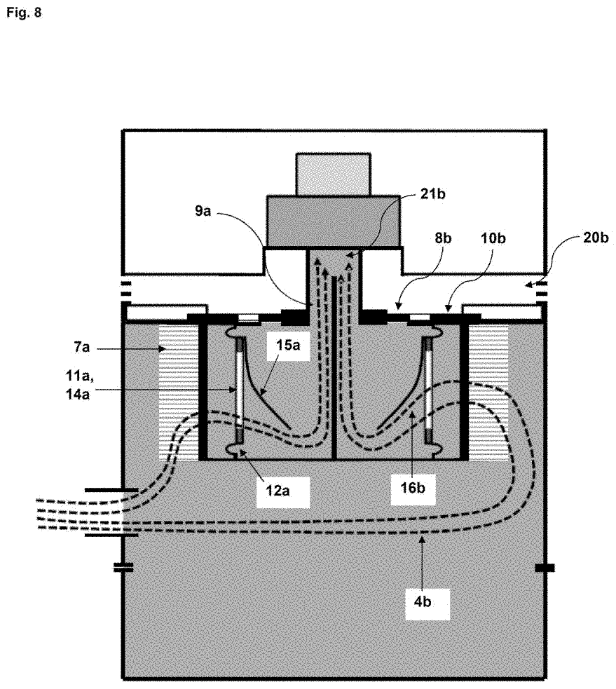

In addition to the membrane plate 14a, the dividing element 11a comprises an elastomer valve 15a (see, e.g., FIG. 8). This elastomer valve 15a is open when the first chamber 6a is working in suction operation. In this state of the elastomer valve 15a, the air stream 4a can pass through the dividing element 11 a and the elastomer valve 15a. The air stream 4a flows in particular through a gap 16a (see, e.g., FIG. 4) that is formed between the membrane plate 14a and the elastomer valve 15a.

The rear space 18a (see, e.g., FIG. 3) of the first chamber 6a has two possible outlets, of which in each case one outlet is open and the other outlet is closed. This interplay is brought about by a valve 10a, which can be moved from a first position into a second position. This actuation takes place preferably by means of a sliding movement of the valve 10a. In other words, the valve 10a can be slid from a first position into a second position. According to the invention, the positions of the valve 10a can also be referred to as the suction operation position and as the filter dedusting position, respectively.

During suction operation of the first chamber 6a—as depicted for example in FIGS. 2 to 5—the valve 10a is set such that a turbine opening 9a of the first chamber 6a is open. Through the open turbine opening 9a, there is a flow connection between the first chamber 6a and the turbine 3. As a result, a negative pressure prevails in the first chamber 6a, and in the entire dust collecting tank 5 of the vacuum cleaner 1, such that dust can be sucked into the interior of the vacuum cleaner through the suction hose inlet 19. In particular, the air stream 4a can pass through the open turbine opening 9a into the region of the turbine 3. To this end, the air stream 4a can flow through a flow channel portion 21a that is provided between the turbine opening 9a and the turbine 3.

FIG. 2 shows a schematic illustration of the vacuum cleaner 1 while both chambers 6a, 6b are participating in suction operation. The dark regions in FIGS. 2 to 8 are intended to represent the regions of the vacuum cleaner 1 in which a negative pressure prevails. In the exemplary embodiment of the invention that is illustrated in FIG. 2, both valves 10a, 10b of the vacuum cleaner 1 are in the suction operation position and the dividing elements 11a, 11b of the two chambers 6a, 6b are each in the parked position, such that the air streams 4a and 4b can flow from the dust collecting tank 5 through the filter elements 7a, 7b in the direction of the turbine 3. In the process, they pass through the dividing elements 11a, 11b and the elastomer valves 15a, 15b, and also the turbine openings 9a, 9b, and thus pass into the flow channel portions 21a, 21b.

The suction operation mode of the vacuum cleaner 1 is in particular characterized in that a negative pressure prevails in the dust collecting tank 5 and in the chambers 6a, 6b that participate in suction operation. This negative pressure also prevails in the flow channel portions 21a, 21b of the chambers 6a, 6b participating in suction operation. The negative pressure is generated by the turbine 3 and the motor 22 and is responsible for the formation of the air streams 4a and 4b that allow air and dust to be sucked into the vacuum cleaner 1.

As a result of the suction operation of the vacuum cleaner 1, the filter elements 7a, 7b can become clogged with dust, with the result that the filtering capacity is reduced. This can represent a risk to the motor 22 and the turbine 3 when these components of the vacuum cleaner 1 are exposed to too much dust. Therefore, the filter elements 7a, 7b of the filter device 2 are regularly dedusted so that for example solidified filter cake 24 can be detached from the filter elements 7a, 7b. To this end, a filter dedusting process is initiated in one of the two chambers 6a, 6b. The start of filter dedusting of the second chamber 6b is illustrated starting with FIG. 3.

In the following text, a filter dedusting process of the second chamber 6b of the vacuum cleaner 1, or of the filter element 7b of the second chamber 6b of the vacuum cleaner 1 is described. This filter dedusting process is started by actuating the valve 10b, which is shifted from the suction operation position into the filter dedusting position. As a result, the turbine opening 9b of the second chamber 6b closes (opening 9b being closed as shown, e.g., in FIG. 3, with the opening 9b being open shown in FIG. 6), while the inflow opening 8b of the second chamber 6b is opened. The inflow opening 8b is connected in a conducting manner to a ventilation channel 20b, which in turn is connected in terms of flow to the environment of the vacuum cleaner 1. As a result of this fluidic connection between the outflow opening 8b and the environment of the vacuum cleaner 1, a pressure equalizing air stream can pass into the second chamber 6b through the inflow opening 8b and so a substantial weakening of the negative pressure in the second chamber 6b occurs. The pressure equalizing air stream is illustrated in the right-hand half of FIG. 3 by the dashed-line air flow. It passes from the environment of the vacuum cleaner into the second chamber 6b through the ventilation channel 20b of the second chamber 6b. In the second chamber 6b, the pressure equalizing air stream ensures that the elastomer valve 15b bears against the membrane plate 14b, with the result that the dividing element 11b is no longer permeable to the air stream 4b. The closing movement of the elastomer valve 15b is indicated by the arrow in FIG. 3. In other words, as a result of the closing of the valve 10b and the closing, caused thereby, of the elastomer valve 15b, the air stream 4b is blocked and the suction stream 4b through the second chamber 6b of the vacuum cleaner 1 is interrupted.

At the same time, as a result of the rapid penetration of the pressure equalizing air stream into the second chamber 6b, the pleats 12b (see, e.g., FIG. 1) are moved from their parked position into the dedusting position. The pulse that is transported into the second chamber 6b by the pressure equalizing air stream ensures an abrupt switchover or folding over of the pleats 12b such that the dividing element 11b likewise moves abruptly in the direction of the filter element 7b, touches the latter and transmits the pulse of the pressure equalizing impact to the filter element 7b. This results in substantial mechanical shaking of the filter element 7b, wherein an intensity of the shock is set such that any solidified filter cake 24 can be detached from the filter element 7b. Furthermore, it is also possible for loose dust located in the filter element 7b to be shaken off by the mechanical shaking. As illustrated in FIG. 4, the detached filter cake 24 drops into the dust collecting tank 5 so that it can be disposed of later together with the rest of the sucked-in dust. It is apparent from FIGS. 3 and 4 that, during the dedusting of the filter element 7b in the second chamber 6b of the vacuum cleaner 1, the air stream 4b is blocked, while the air stream 4a can continue to flow through the first chamber 6a of the vacuum cleaner 1.

Provision can also be made according to the invention for the transmission of the pulse of the pressure equalizing air stream between the dividing element 11b and the filter element 7b to take place in a contactless manner. In this case, the dividing element 11b and the filter element 7b are designed such that the abrupt compression of the air in the front region 17b of the second chamber 6b is enough to bring about sufficiently great mechanical shaking of the filter element 7b. The exploitation of a pulse of a pressure equalizing air shock for providing efficient filter dedusting with simultaneously continuing suction operation of a vacuum cleaner can preferably also be referred to as backflushing or a backflushing process according to the invention.

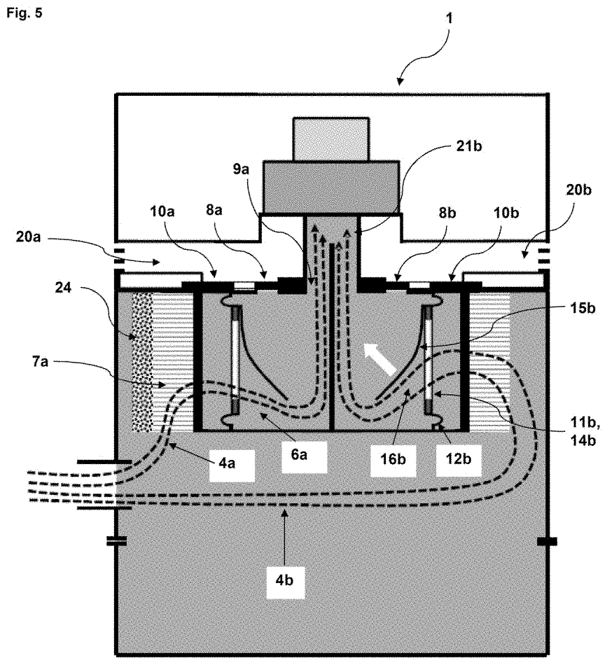

FIG. 5 shows a schematic illustration of the vacuum cleaner 1 at the end of the dedusting process of the second chamber 6b. The end of the dedusting process is again started by actuation of the valve 10b. In particular, the valve 10b is now slid back from the dedusting position into the suction position. As a result, the turbine opening 9b is opened again, while the inflow opening 8b, which allows the flow connection with the environment of the vacuum cleaner 1, is closed. As a result, a negative pressure can build up in the second chamber 6b again, as is necessary for carrying out suction operation. In particular, a suction air stream 4b flows again from the dust collecting tank 5 into the second chamber 6b and the elastomer valve 15b of the dividing element 11b opens again. The opening movement of the elastomer valve 15b is indicated by the white arrow in FIG. 5. Furthermore, the membrane plate 14b passes from the dedusting position back into the parked position. This is brought about in particular by a further switchover or folding over of the pleats 12b, which likewise jump back from the dedusting position into the parked position of suction operation. Furthermore, the movement of the membrane plate 14b from the parked position into the suction operation position is supported by additional restoring forces, which result from the incipient flow through the dividing element 11b.

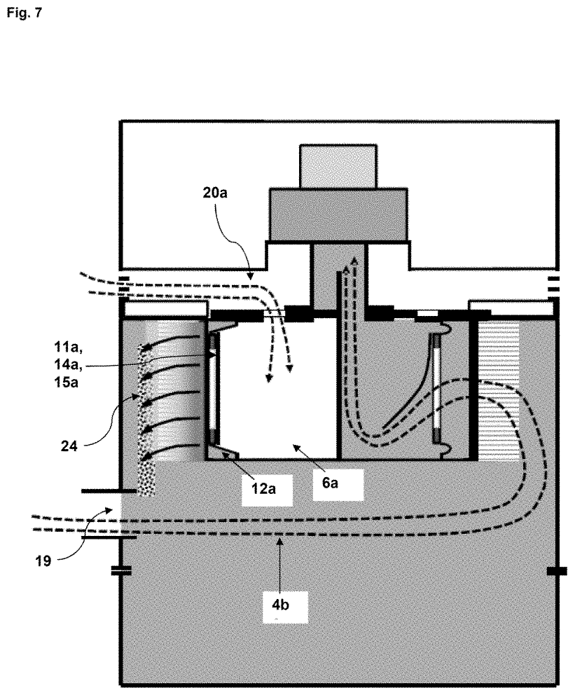

FIGS. 6 to 8 show a filter dedusting process of the first chamber 6a of the filter device 2. In this case, the contents of FIGS. 3 and 6, 4 and 7 and 5 and 8 correspond in each case, wherein the reference signs “b” in the description should be replaced by an “a”. Therefore, a detailed explanation of FIGS. 6 to 8 will not be given. It is apparent from FIGS. 6 and 7 that, during the dedusting of the filter element 7a in the first chamber 6a of the vacuum cleaner 1, the air stream 4a is blocked, while the air stream 4b can continue to flow through the second chamber 6a of the vacuum cleaner 1.

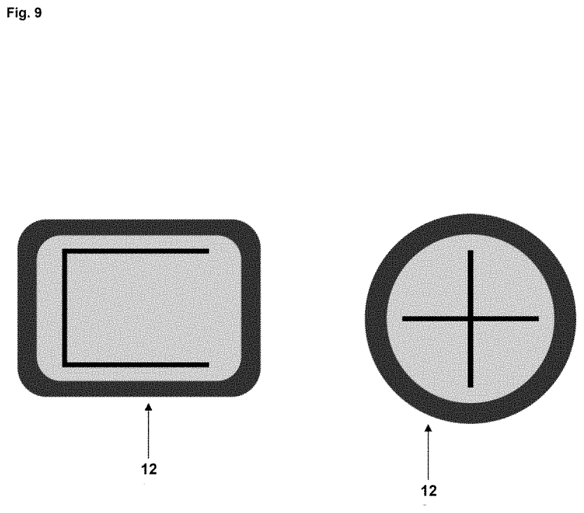

FIG. 9 shows possible configurations of the pleat 12a, 12b. The inner region of the pleat 12 is formed by an elastomer pleat, which preferably consists of elastic material. It preferably has an indentation, which may have for example the shape of a cross or of an open rectangle. The elastomer pleat is preferably surrounded by the membrane plate 14, which connects the pleat 12 to the dividing element.

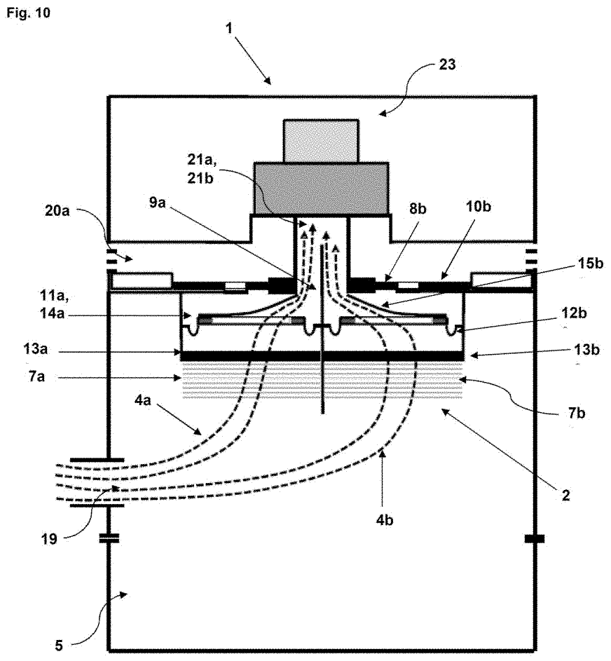

FIG. 10 shows a schematic side view of a vacuum cleaner 1 having a preferred embodiment of the filter device 2 in a horizontal arrangement. What is illustrated is a vacuum cleaner 1 having a vacuum cleaner head 23 in an upper region and a dust collecting tank 5 in a lower region of the vacuum cleaner 1. The turbine 3 and the motor 22 are provided in the vacuum cleaner head 23. The dust collecting tank 5 has a suction hose inlet 19 for connecting a suction hose. Provided in the dust collecting tank 5 are two chambers 6a, 6b, which, in the configuration of the vacuum cleaner 1 illustrated in FIG. 10, are flowed through by air streams 4a, 4b that flow from bottom to top, while the direction of flow in the vacuum cleaner 1 in FIG. 1 (vertical arrangement of the chambers 6a, 6b) is in a lateral direction from right to left or from left to right.

On flowing through the chambers 6a, 6b, the air streams 4a, 4b first of all pass through the filter elements 7a, 7b before they pass through the inlet openings 13a, 13b into the front part 17a, 17b of the chambers 6a, 6b. From there, the air streams 4a, 4b continue on their way through the dividing elements 11a, 11b and through the elastomer valves 15a, 15b until they pass, in suction operation, through the turbine openings 9a, 9b into the flow channel portions 21a, 21b upstream of the turbine 3. In the process, the turbine openings 9a, 9b are opened up by the valves 10a, 10b in the case of suction operation.

In the case of dedusting, the valves 10a, 10b can be slid into the dedusting position, such that the turbine openings 9a, 9b are then closed and the outflow openings 8a, 8b open. The inflow openings 8a, 8b are fluidically connected to the ventilation channels 20a, 20b, which are in a flow connection with the environment of the vacuum cleaner 1. In this way, pressure equalizing streams can pass into the chambers 6a, 6b through the outflow openings 8a, 8b. These pressure equalizing streams weaken the negative pressure in the chamber to be dedusted and close the elastomer valves 15a, 15b of the dividing elements 11a, 11b and ensure that the dividing elements 11a, 11b move in the direction of the filter elements 7a, 7b. The pulses of the pressure equalizing streams can then be transmitted from the membrane plate 14a, 14b to the filter elements 71, 7b by contact or contactlessly, with the result that the filter elements 7a, 7b are mechanically shaken. This in turn results in effective dedusting of the filter elements 7a, 7b.

Tests have shown that especially a horizontal arrangement of the filter device 2 can result in a particularly compact vacuum cleaner 1, in which the filter device 2 takes up only a little installation space.

### LIST OF REFERENCE SIGNS

1 Vacuum cleaner
2 Filter device
3 Turbine device
4 Main air stream, 4a: first main air stream, 4b: second main air stream
5 Collecting tank
6 Chamber, 6a: first chamber, 6b: second chamber
7 Filter element, 7a: first filter element, 7b: second filter element
8 Inflow opening, 8a: first inflow opening, 8b: second inflow opening
9 Turbine opening, 9a: first turbine opening, 9b: second turbine opening
10 Valve, 10a: first valve, 10b: second valve
11 Dividing element, 11a: first dividing element, 11b: second dividing element
12 Pleat, 12a: pleat in the first chamber, 12b: pleat in the second chamber
13 Inlet opening, 13a: first inlet opening, 13b: second inlet opening
14 Membrane plate, 14a: first membrane plate, 14b: second membrane plate
15 Elastomer valve, 15a: first elastomer valve, 15b: second elastomer valve
16 Gap, 16a: first gap, 16b: second gap
17 Front space in a chamber (17a: front space of the first chamber 6a, 17b: front space of the second chamber 6b)
18 Rear space in a chamber (18a: rear space of the first chamber 6a, 18b: rear space of the second chamber 6b)
19 Suction hose inlet
20 Ventilation channel
21 Flow channel portion

### 22 Motor

23 Vacuum cleaner head
24 Filter cake
25 Partition wall

What is claimed is:

1-15. (canceled)

16. A filter device for a vacuum cleaner having a turbine device and a motor for generating a first main air stream or a second main air stream through a collecting tank of the vacuum cleaner, the filter device comprising:
a first chamber and a second chamber, each with a filter element, an inflow opening and a turbine opening, wherein a valve is designed to close either the inflow opening or the turbine opening, wherein a negative pressure prevails in the chamber when the inflow opening is closed and wherein atmospheric pressure prevails in the chamber when the inflow opening is open,
the first and second chambers also each including a divider having a parked position and a dedusting position, a switchover between the parked position and the dedusting position taking place by letting in atmospheric pressure by actuating the valve, the dividers being designed to apply a pulse to the respective filter element when the dedusting position is taken up so that the filter element is dedusted.

17. The filter device as recited in claim 16 wherein a negative pressure prevails in the collecting tank and in at least one of the first and second chambers during operation of the vacuum cleaner.

18. The filter device as recited in claim 16 wherein the switchover between the parked position and the dedusting position of the dividing elements takes place via a pleat.

19. The filter device as recited in claim 16 wherein the turbine openings are designed to allow a flow connection between the chambers and the turbine device.

20. The filter device as recited in claim 16 wherein the chambers have inlet openings and wherein the filter elements are designed to close the inlet openings such that dust particles are filtered out of the first and second main air streams.

21. The filter device as recited in claim 16 wherein the dividers each have a membrane plate.

22. The filter device as recited in claim 21 wherein the dividers also have elastomer valves designed to prevent an air flow through the membrane plate in that the elastomer valves bear in an airtight manner against the membrane plate, or wherein the elastomer valve are designed to form, with the membrane plate, a gap through which an air flow can flow.

23. The filter device as recited in claim 22 wherein the gap between the elastomer valve and membrane plate is formed in that the elastomer valve is fastened to the membrane plate on one side and can be present at a spacing from the membrane plate on the other side of the membrane plate.

24. The filter device as recited in claim 16 wherein a front space is formed in each of the first and second chambers between the filter element and the divider and a rear space includes the outflow opening and the turbine opening.

25. The filter device as recited in claim 16 wherein ventilation channels are provided between the collecting tank and a vacuum cleaner head.

26. A method for dedusting a filter device in a vacuum cleaner, the method comprising the following steps:
a) providing the filter device as recited in claim 16;
b) operating the vacuum cleaner, wherein, during operation of the vacuum cleaner, a negative pressure prevails in a collecting tank of the vacuum cleaner and in at least the first chamber or the second chamber;
c) generating atmospheric pressure in one of the first and second chambers by actuating the respective valve, wherein, as a result of the valve being actuated, the turbine opening of the one chamber is closed and an inflow opening of the one chamber is opened and furthermore the divider within the chamber is made to change position from the parked position into the dedusting position; and
d) dedusting the filter element by the change in position of the divider.

27. The method as recited in claim 26 wherein when the vacuum cleaner is in operation, a first main air stream or second main air stream is generated, the first or second main air stream forming between a suction hose inlet and the turbine device.

28. The method as recited in claim 26 wherein when the inflow opening is opened, a pressure equalizing stream passes into the first chamber or into the second chamber from a ventilation channel.

29. The method as recited in claim 26 wherein during operation of the vacuum cleaner, there is a flow connection between the first and second chambers and the turbine device, wherein the flow connection is formed by a flow channel portion arranged between the respective turbine opening and the turbine device.

30. The method as recited in claim 26 wherein the filter element of one of the first and second chambers is dedusted upon continued suction operation through the other of the first and second chambers.
